(19) United States
(12) Patent Application Publication
(10) Pub. No.: US 2002/0025053 A1
(43) Pub. Date: Feb. 28, 2002

(54) Speaker alignment tool

(76) Inventors: George H. Lydecker, Burbank, CA (US); Alan J. McPherson, Chatsworth, CA (US)

Correspondence Address: GOTTLIEB RACKMAN & REISMAN PC, 270 MADISON AVENUE, 8TH FLOOR, NEW YORK, NY, 100160601

(21) Appl. No.: 09/781,647

(22) Filed: Feb. 12, 2001

Related U.S. Application Data
(60) Provisional application No. 60/181,751, filed on Feb. 11, 2000.

(51) Int. Cl. H04R 5/02

(52) U.S. Cl. 381/305; 381/300; 381/303

(57) ABSTRACT

A device or tool to place objects such as speakers at an equal distance from a reference point has a supporting base with a center to be placed at the reference point. Beam generators are mounted on an azimuth locating mechanism rotatable on said base. The beam generators generate light beams which are first directed at one speaker and their relative location is fixed. The mechanism is rotated sequentially toward each predetermined location for the other speakers and the beams impinging on the speakers are used to locate their optimal positions.

### RELATED APPLICATIONS

This invention claims priority to U.S. Provisional application 60/181,751 filed Feb. 10, 2000 and incorporated herein by reference.

### BACKGROUND OF THE INVENTION

1. Field of the Invention

This invention relates to devices and systems for positioning objects with respect to a reference point. More particularly, this invention relates to a device used for positioning objects such as speakers at predetermined positions with respect to a reference point, said speakers being part of a multichannel audio or audio/visual replay system.

2. Description of Related Art

In the 1970's, Dolby Laboratories Inc. of San Francisco, Calif. developed a method to encode four channels of audio information into the two tracks that were available on a standard 35 mm film. The Dolby Stereo method encodes a left, center, and right and surround audio channel into the two tracks of standard stereo. This accommodated the left and right speakers at the screen, as well as a center speaker behind the screen and a series of surround speakers placed around the side and/or the back of a cinema theater. The two tracks from the film were fed into a decoder, and then are equalized according to their function and location in the cinema. The surround audio signals undergo a delay so that the front sounds from the left, right, and center speakers reach all the listeners in the cinema before the rear sounds from the surround speaker do.

In 1982 Dolby Laboratories introduced Dolby Stereo for the home market known as Dolby Surround Sound. The four encoded channels were now available in the home. In many early systems, the center channel was not recovered, but was divided between the left and right speakers to create a phantom center speaker. The later introduction of the Dolby Pro Logic Decoder around 1987 made it possible to decode the center channel directly and also introduced advanced steering methods for the sound image. Similar techniques are used in modern recordings, for example, sound or multi-media recordings on DVDs. These recordings can then be replayed by an audio or audio/visual system as 5 or 5.1 audio channels, each channel corresponding to a speaker.

For example, referring now to FIG. 1, five speakers for five channels can be positioned within an exhibition space, whether that space is a theater or a home entertainment area. It has been determined that the optimum placement of the center speaker CF is directly in front of a desired center or reference point CC. A reference axis REF passes through the center speaker CF and the center point CC. The left front speaker LF and right front speaker RF are then placed at an angle of approximately ±30° from the reference axis REF. The remaining speakers LR and RR are placed at an angle of 110°±10° with respect to the reference axis REF.

Moreover, each speaker CF, LF, RF, LR, and RR should be placed at an equal distance D from the center point CC. In other words, ideally, the speakers should placed on a circle of radius D with the center at CC. Of course, the number and spacing of the speakers can be changed and the device can be used to place speakers in any configuration.

Normally, the placement of the speakers is done by either rough estimation or by use of sophisticated and complicated surveying tools such as transits similar to that described in U.S. Pat. No. 5,218,770 (Toga).

Laser light emitting pointing devices are well known in the art and are used to provide reference lines as described in U.S. Pat. No. 5,838,431 (Hara et al.). In Hara a laser diode emits a laser light that is optically manipulated and then mechanically rotated to form the reference line. Further, laser emitting devices have been used to provide reference points for the control and movement of one object with respect to another as shown in U.S. Pat. No. 5,343,295 (Lara et al.). In Lara et al., laser-emitting devices are used to provide a reference point to guide an electric vehicle to dock with a charging station.

### OBJECTIVES AND SUMMARY OF THE INVENTION

An objective of this invention is to provide a device or tool to place objects such as speakers at predetermined locations around a reference point.

A further objective is to provide a device which can be easily adapted to various speaker configurations.

A further objective is to provide a device which includes or has incorporated therein a distance detector that can be used at least to determine if a speaker is within a predetermined range therefrom. Other objectives and advantages of the invention shall become apparent from the following description.

Briefly, a device for positioning several objects with respect to a reference point includes a base having a center, a plurality of pointers arranged radially with respect to said center, each pointer indicating an angular position for one of said objects, and an azimuth locating mechanism rotatably mounted on said base and including a beam generator adapted to generate a light beam, wherein said azimuth locating mechanism is adapted to position said beam generator to orient said light beam along one of said pointers thereby indicating a position for the respective object.

Advantageously, the device may also include a distance calculator which may be mounted on said azimuth locating mechanism and is adapted to indicate a distance to one of said objects. Preferably, the first object is placed in its position and the device is then set for the distance between it and the first object. The device is then rotated to preset angular positions and the light beam then indicates the positions of subsequent objects.

Preferably the pointers are associated with or inscribed on a top surface of the plate. Alternatively, the pointers can also be placed on the side of the plate. The azimuth locating mechanism is provided with a direction indicator which can be used to position the mechanism with respect to the pointers. In this manner the mechanism and the pointers cooperate to define a distinct axis for each speaker.

Preferably the beam generator can rotate with respect to a plane parallel to the base to allow the object to be positioned either above below the base.

In one embodiment of the invention, the azimuth locating mechanism includes a first and a second beam generator, the beam generators being adapted to be selectively rotatable with respect to each other. The beam generators generate images on the object to be positioned. More specifically, the beam generators are adapted to generate spots on the object to be positioned, the relative position of the spots being indicative of the position of the object.

In another embodiment, azimuth locating mechanism includes a distance indicating mechanism adapted to indicate a radial distance to the object to be positioned. This distance indicating mechanism may be an ultra-acoustic device, a radar range detector or an optical device. The optical device is adapted to generate images. Relative distance is indicated by the relative position and sharpness of the images.

In one aspect, the device includes a supporting base having a center to be placed at the reference point. A first bracket is rotatably mounted on the supporting base, preferably at its center. The bracket supports two arms, each arm being used to mount one of the beam generators. The first arm is attached to an end of the bracket, it extends substantially horizontally and is rotatable about its longitudinal axis. The second arm is mounted to an end of the first arm and is rotatable about a vertical axis perpendicular to the base.

A first locking mechanism is used to couple the bracket to the base. When released, this locking mechanism allows the first arm to rotate both beam generators about the vertical axis. When secured, the first locking mechanism prevents the first arm and thus the beam generators from movement in relation to the supporting base.

A second locking mechanism connects the second arm to the first arm in proximity of the vertical axis of the first locking mechanism. The second locking mechanism when released allows the second arm to rotate the second beam generator about a vertical axis. When secured the second locking mechanism prevents the second beam generator from movement in relationship to the first arm and thus the first beam generator.

In an alternate embodiment of the invention, a single beam generator is used to determine a distance of a speaker to the reference point and its optimal angle with respect to a reference line.

The device is used as follows. The device is placed at the reference point and a preselected speaker, for example the front center speaker, is placed in position. The two beams from the device are directed to the center of this speaker and their relative position is then locked. Next, using the pointers provided for this purpose, the azimuth locating mechanism is sequentially located toward each predetermined position. The respective speaker is placed along this direction with the beams impinging on the speaker. The speaker is in its designated place when the spots or images resulting from the beams appear in a predetermined spacial relationship.

### BRIEF DESCRIPTION OF THE DRAWINGS

FIG. l shows the optimal placement of speakers for a multi-media system.

FIG. 2 shows a perspective view of an object alignment device constructed in accordance with this invention.

FIG. 3 shows a rear elevational view of the object alignment device of FIG. 2.

FIGS. 4, 5 and 6 show diagrams illustrating the method of placing an object such as a speaker using the object alignment device of FIGS. 2 and 3.

FIG. 5a shows the orientation of the spots on a speaker generated by the beam generators.

FIG. 7 shows a perspective view of the object alignment device incorporating a supporting pedestal.

FIG. 8 shows a somewhat diagrammatic view of the second embodiment of the invention.

FIG. 9 shows a somewhat diagrammatic view of third embodiment of the invention.

FIGS. 1Oa and 1Ob somewhat diagrammatic views of a fourth embodiment of the invention.

FIG. 11a is a rear elevational view of fifth embodiment of the invention.

FIG. 11b is a simplified diagram of the beam generator for the fifth embodiment of Fig. 11a.

### DETAILED DESCRIPTION OF THE INVENTION

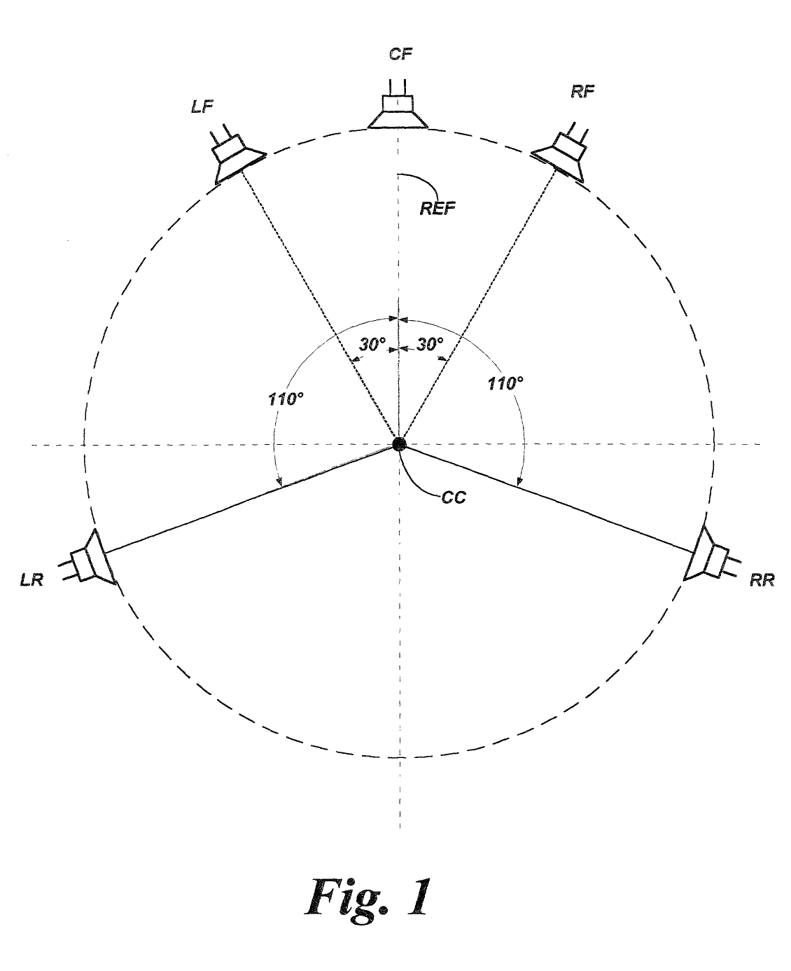

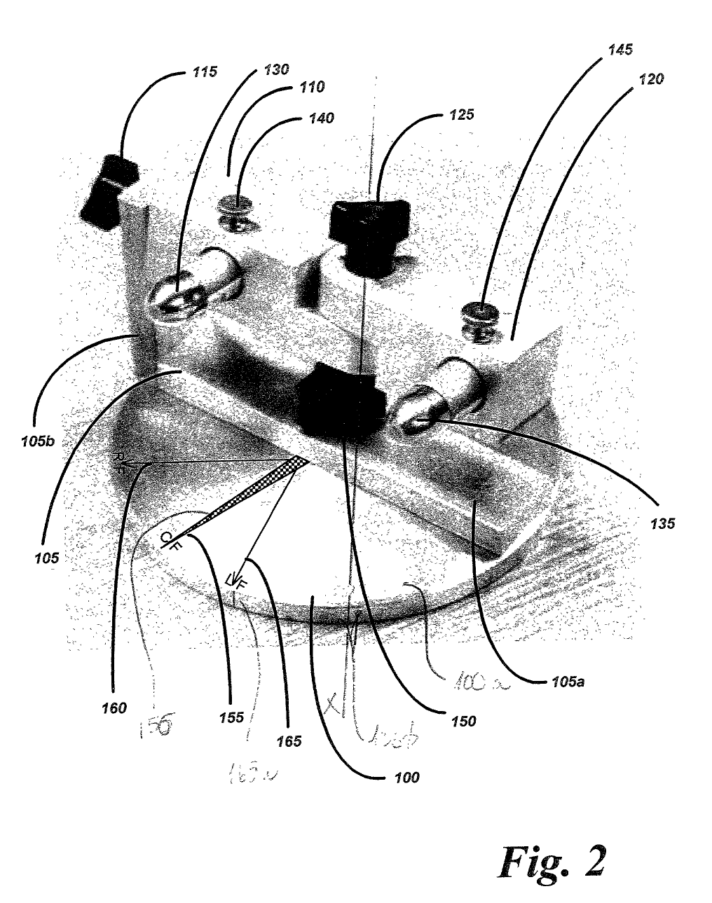

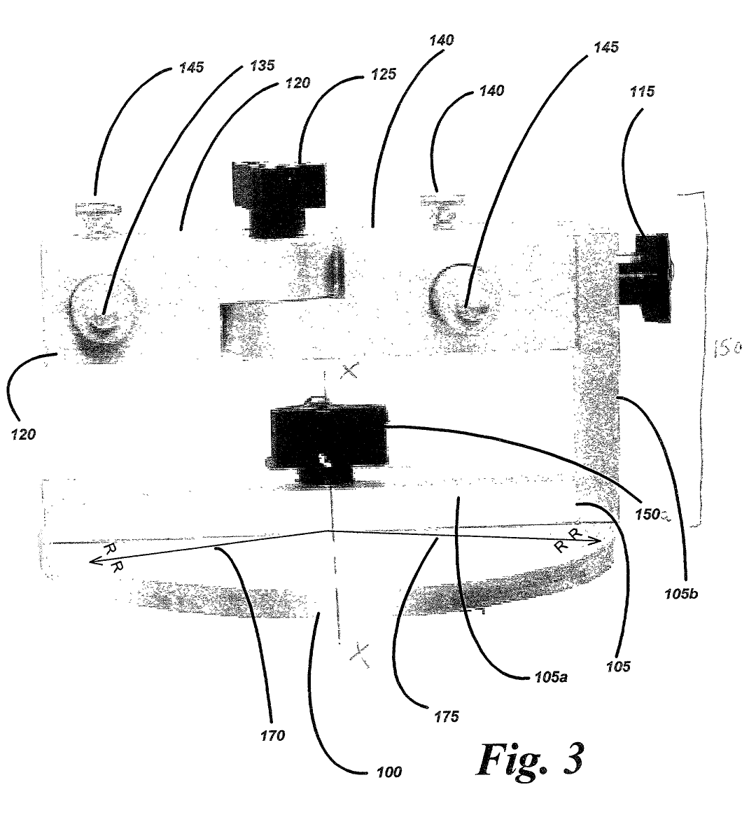

As discussed above, the present invention pertains to a device or tool used to position several objects, such as the speakers of a multi-media system with respect to a reference point. More particularly, as shown in FIG. 1, the subject invention can be used to position, speakers LF, CF, RF, RR and LR around a reference point CC. Since, optimally, all the these speakers are placed at a common distance D from point CC, the speakers are in essence placed along the periphery of an imaginary circle C having diameter D. Using the imaginary line REF between the speaker CF and reference point CC as a reference, the speakers LF and RF are then placed along the circle C at ±30° from speaker CF and speakers RR and LR are placed at ±110° , as shown. The optimal angles for the speakers have been discussed above, Referring now to FIGS. 2 and 3, a device or tool 10 is shown which is constructed in accordance with this invention to assist in the alignment of speakers of FIG. 1 for a multi-media system. The device 10 includes a supporting base plate 100 having a generally circular disk shaped plate with a center adapted to receive an azimuth locating mechanism 150. This mechanism 150 includes an L-shaped bracket pivot arm 105 which is formed of the two bars 105a and 105b. The bracket pivot arm 105 is coupled to the supporting base plate 100 by an azimuth locking knob 150a. When the azimuth locking knob 150a is secured, the azimuth locating mechanism 150 is prevented from rotating with respect to the center of the supporting base plate 100. When the azimuth locking knob 150a is released, the azimuth locating mechanism can be rotated about a vertical axis X-X generally passing through the center of the supporting base plate 100.

As can be seen in the Figures, bar 105a a is generally horizontal and bar 105b is generally vertical. Attached to the top end of bar 105b is an altitude adjustment bracket 110 parallel to bar 105a. A beam generator 130 is placed in an opening(not shown) within the altitude adjustment bracket 110 and secured with the setscrew 140. The beam generator 130 is, in the preferred embodiment, a laser light emitting device known in the art. The altitude-adjusting arm 110 has an end 11Oa distal from bar 105b. The beam generator 130 generates a beam 132 which is generally perpendicular to arm 110.

The altitude adjusting arm 110 is secured to the bar 105b by a locking mechanism 115. The locking mechanism 115 is generally a self-locking fastener that allows the altitude adjusting arm 110 to rotate about the longitudinal axis of the altitude adjusting arm 110. When the altitude locking mechanism 115 is secured the altitude adjustment arm 110 is prevented from being able to rotate.

Another arm 120 is coupled to the altitude-adjusting arm 110 by a locking mechanism 125. The arm 120 has an end 120a superimposed over end 11Oa. Locking mechanism 125 is a self-locking fastener that allows rotation of the arm 120 about the vertical axis X-X with respect to arm 110. When the range locking mechanism is secured, the arm 120 remains fixed with respect to the altitude adjustment arm 11Oa and bracket pivot arm 105.

The arm 120 has an opening to accept a second beam generator 135, which in a first embodiment is also a diode laser. The beam generator 135 is retained within the range-determining bracket 120 by the setscrew 145. The beam generator 135 is set within the arm 120 so that it generates a beam 137 which is essentially perpendicular to the longitudinal axis of arm 120.

A plurality of pointers 155,160, 165,170 and 175 are imprinted or otherwise marked the top surface 100a of supporting base plate 100 denoting the reference line REF toward center speaker CF and the ideal reference lines toward the right front RF, left front LF, right rear RR and left rear LF speaker, respectively. Attached to bar 105a is a position indicator 156 which may be used to indicate the position of the azimuth locating mechanism 150 with respect to the pointers on the plate 100. Alternatively, the pointers can be positioned on the cylindrical sidewall 100b of plate 100, as shown at 165a. For this configuration, the position indicator may be a line (not shown) provided on the outer surface of bar 105b adjacent to surface 100b.

Referring now to FIGS. 1, 4, 5, and 6 the device or tool 10 is used as follows. First, device 10 is positioned at the reference point CC. Next, one of the speakers, for example the center front speaker CF is placed generally in front of the device 10 on reference line REF and at distance D, as shown in FIG. 1. This distance may be set using a standard measuring tape, a ruler, an electronic distance measuring device, or other similar means. Such a measuring device may be optionally incorporated into the device 10 as discussed in more detail below.

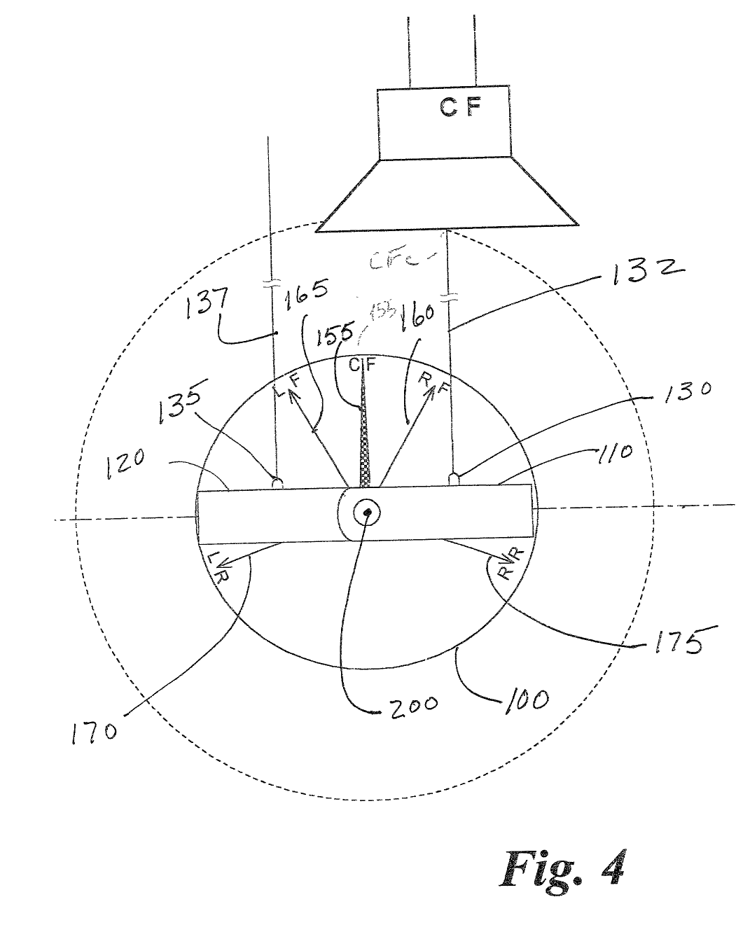

As shown in FIG. 4, the device 10 is arranged so that the azimuth locating mechanism is positioned with the direction indicator 156 superimposed on the pointer 155 (corresponding to the center front position) and the beam generators 130 and 135 each generate a light beams 132,137. After the device 10 and speaker CF have been positioned as discussed above, the reference beam generators 130, 135 are activated and the position of speaker CF is adjusted so that the beam from one of the beam generators, for example beam 132 falls on its center CFc.

Alternatively, the device 10 can be placed first at reference point CC and the speaker CF can be positioned after the beam generators 130, 135 have been activated.

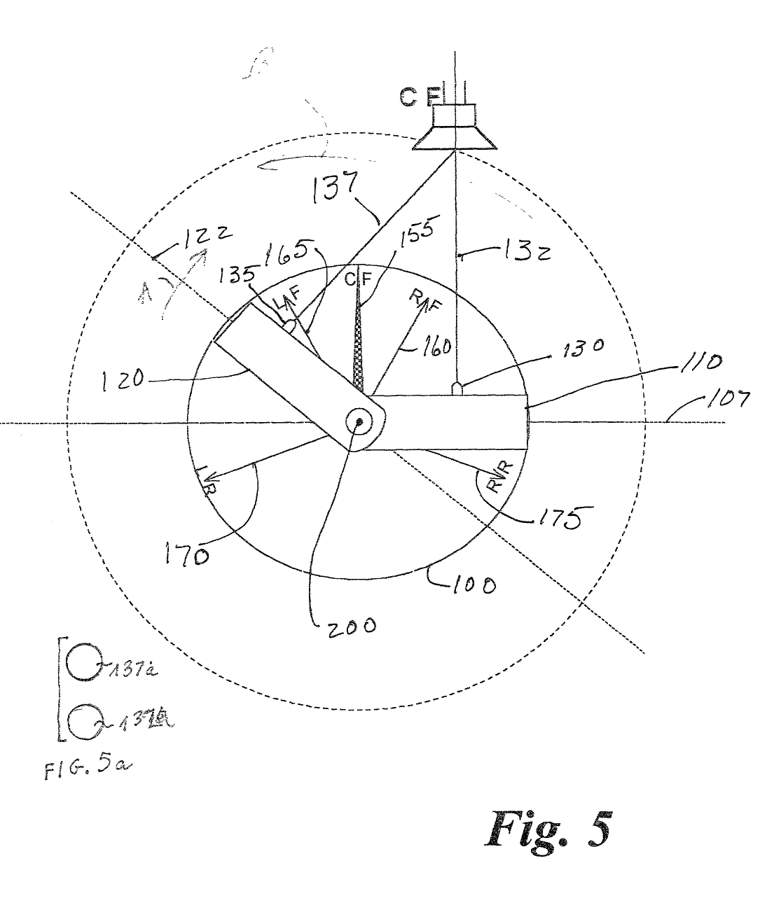

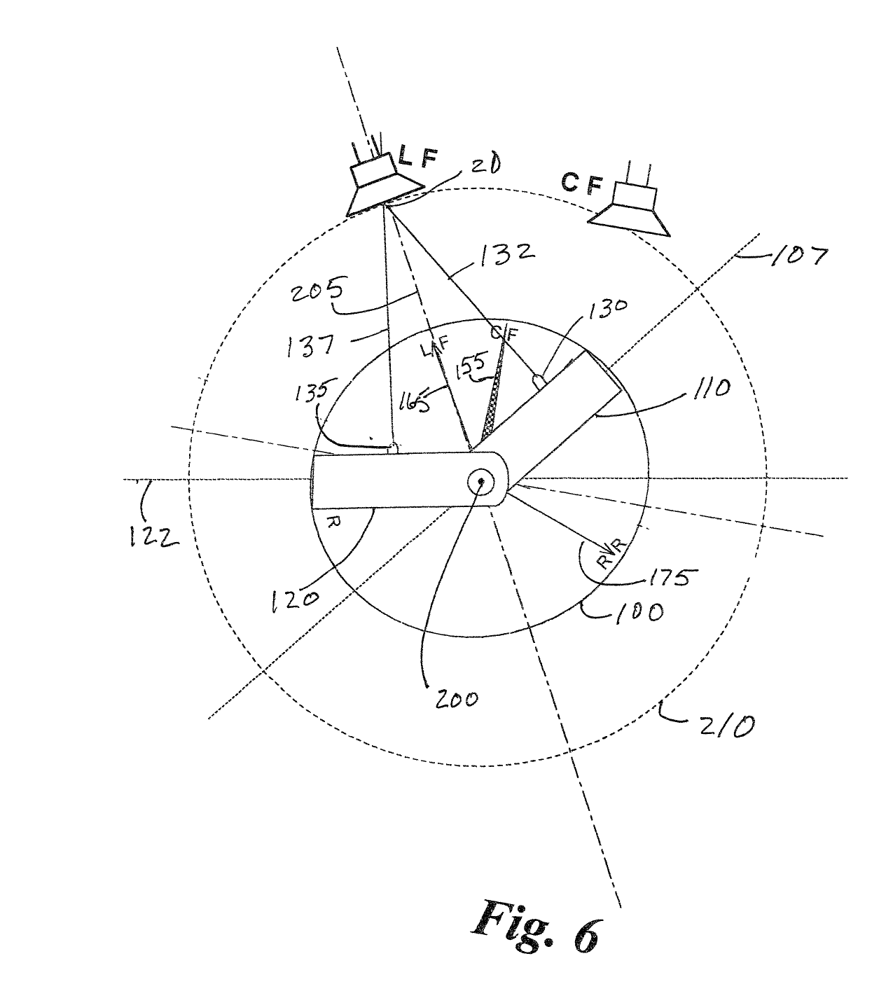

Referring now to FIG. 5, next, the locking mechanism 125 is released and arm 120 is pivoted clockwise as indicated by arrow A until the spot on speaker CF corresponding to the beam 137 coincides with, or falls on the spot formed corresponding to beam 132.

Preferably, the beam generators 130 and 135 are arranged and positioned so that their beams are not exactly coplanar but one beam is offset slightly in the vertical direction from the other. As a result, the two spots resulting from these beams are offset vertically as well. More particularly, as shown in FIG. 5a, the beam generators 130,135 can be arranged so that spot 137a from beam generator 135 appears above spot 132a from beam generator 130. Once arm 120 has been rotated sufficiently to position the spot 137a above spot 132a as shown in FIG. 5a, the locking mechanism 125 is tightened thereby locking the arm 120 with respect to arm 110.

Once arm 110 is locked into place, all the elements of the azimuth locating mechanism 150 and the next speaker, such as speaker LF can be positioned. For this purpose, lock 150a is released and the azimuth locating mechanism 150 is rotated, as indicated by the arrow B in FIG. 5 counterclockwise until direction indicator 156 coincides with pointer 165. The speaker LF is positioned so that the spots from beams 132, 137 fall on its center and line up vertically as shown in FIG. 5a. The vertical offset between the spots 132a and 137a provide guidance on which way to move the speaker. If the spot 137a is to the left of spot 132a, the speaker LF is too close to the reference point CC. If the respective positions of the spots are reversed, the speaker is too far from the reference point CC and device 10.

The remaining speakers (RF,RR, RL) can be similarly positioned using the methodology described above. That is, the azimuth locator mechanism 150 is repositioned so that its direction indicator 156 lines up with the appropriate pointer. The respective speaker is then placed at the location indicated by the two beams 132,137.

In this manner, by successively positioning the position indicator 156 on the respect pointers, and placing the speakers at the locations indicated by the resultant beams, in effect allows the speakers to be disposed around the circumference of circle C.

Speakers are often placed in positions above the horizontal plane that including the device 10. In this case, the superposition 201 of the reference markers of the reference axes 132 and 137 must be set above the horizontal plane. To accomplish this, the altitude adjustment locking mechanism 115 is released and the altitude adjustment arm 110 and arm 120 are rotated about the longitudinal axis of arm 110 sufficiently to reach the desired speaker altitude.

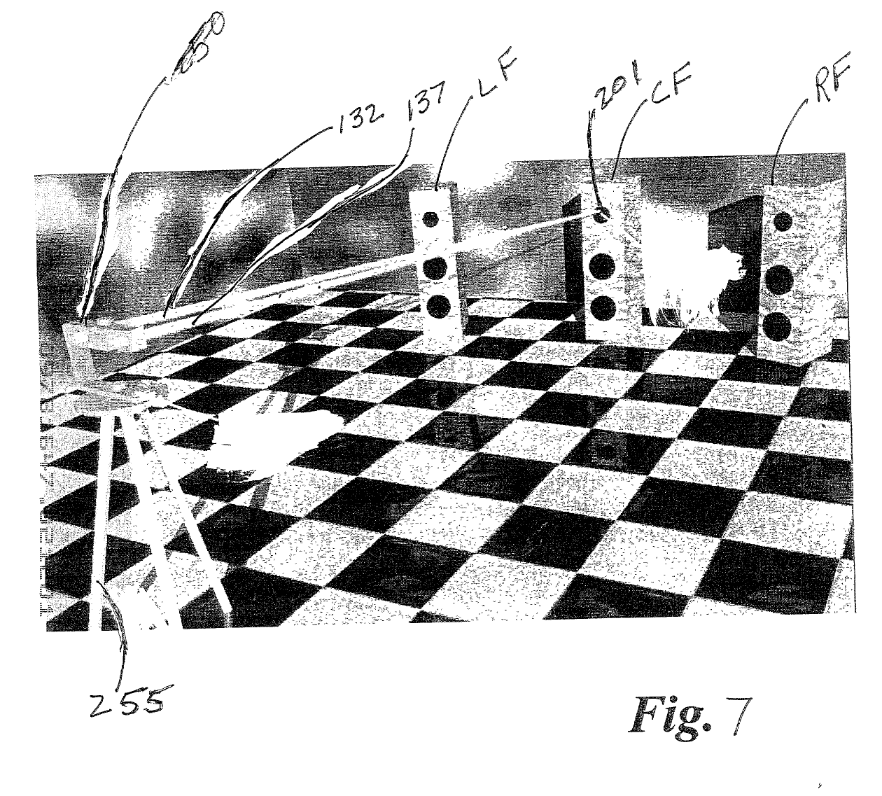

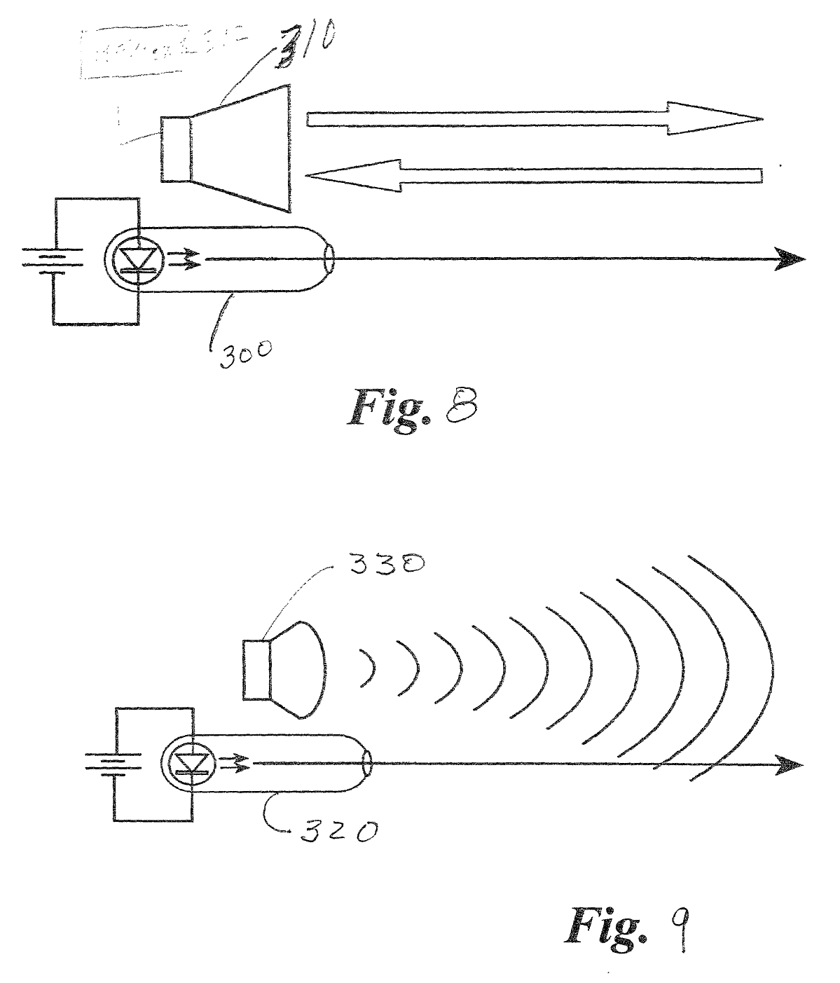

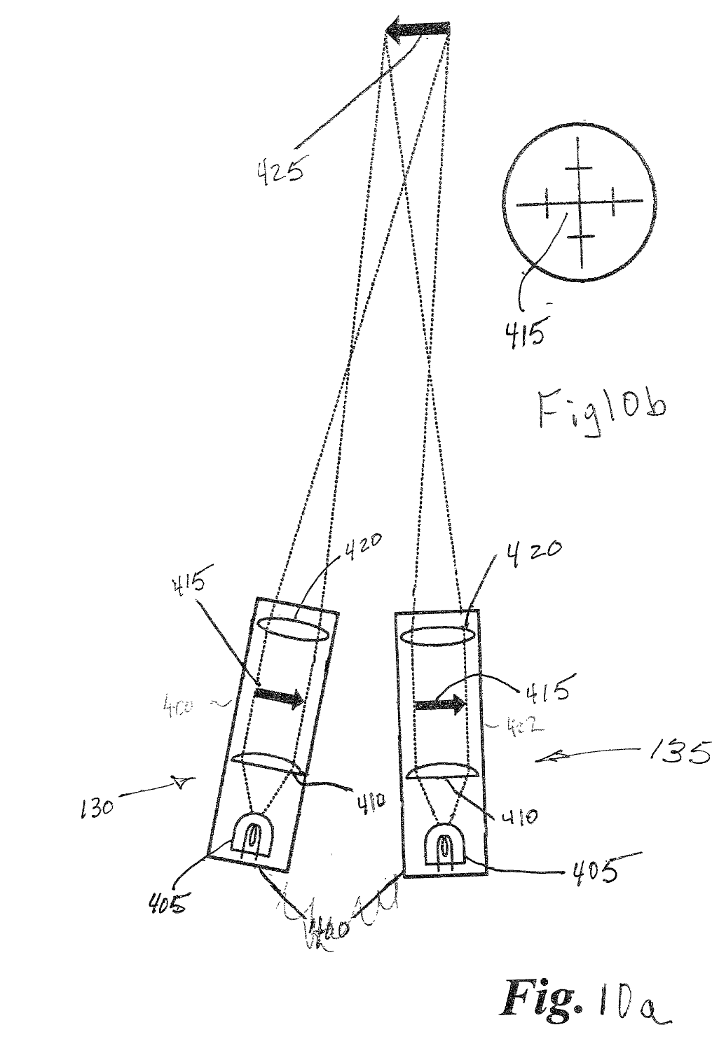

As shown in FIG. 7, the device 10 may be mounted on a pedestal or tripod 255 to support it. The tripod 255 acts to elevate the device 10 as shown. In either case, it is clear that the two beam generator cooperate to define the desired position a speaker by an azimuth and a distance from the reference point.

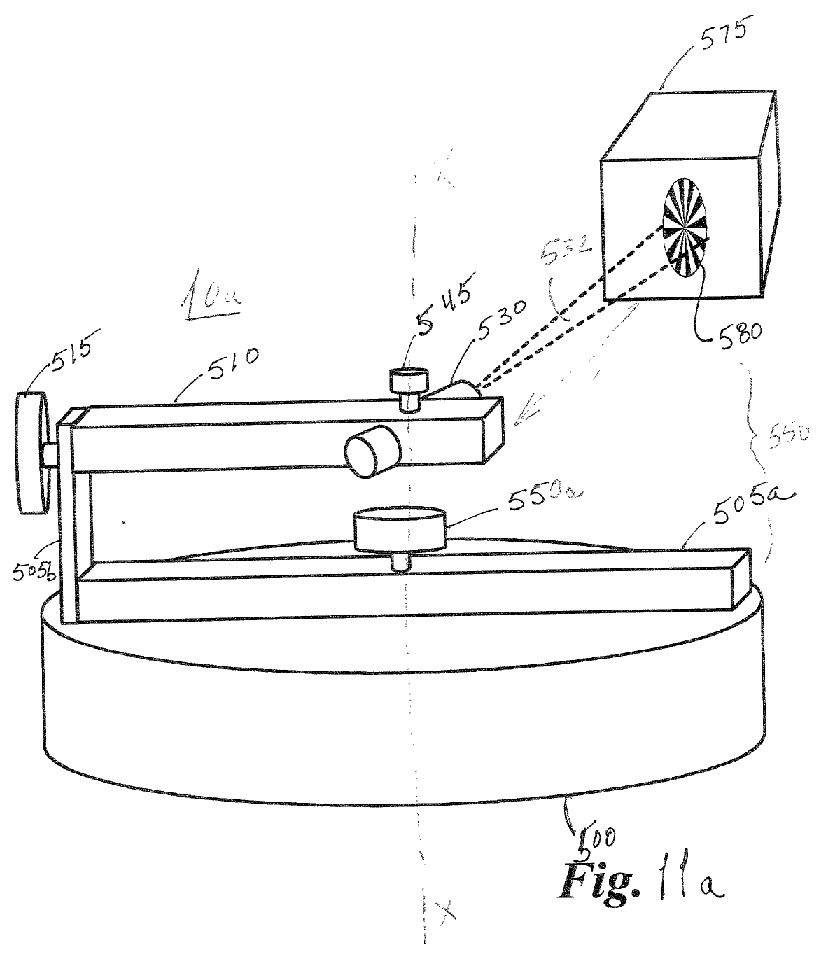

Referring now to FIGS. 2 and 8, in a second embodiment of the invention, one of the beam generators is replaced by a distance or range indicator. The basic structure is as described above in conjunction with the FIGS. 2-7. The beam generator 130 comprises a laser-emitting device 300. Beam generator 135 is replaced by a radar range-determining device 310. The primary object, i.e., speaker CF is placed in front of the device along an axis defined by the beam from laser device 300. As described above, The range-determining reference pointer 135 is then rotated to aim its center locator to the speaker CF. The range is then determined and recorded by known methods such as digitization of the range and stored in a memory device 312.

To place each next speaker and the remaining objects, the modified azimuth locating mechanism is rotated to the designated angles, a new object is positioned first along the respective axis, and then the ranging device is used to determine the range to the object, and to compare the same to the standard measurement (distance D) stored in memory 312.

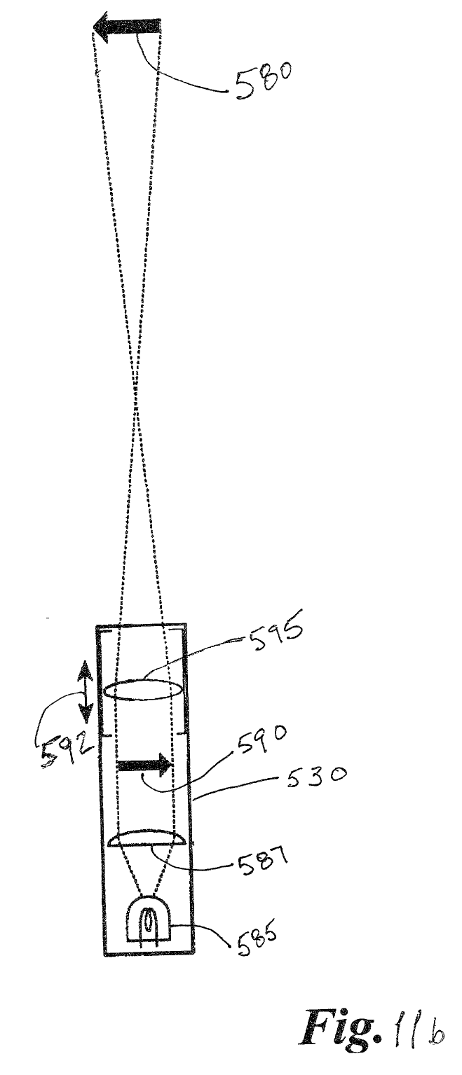

A third embodiment of the subject device is shown somewhat diagrammatically in FIG. 9. The basic structure is as above described. The beam generator 130 comprises a laser-emitting device 320. The beam generator 135 is replaced by an ultrasonic range-determining device 330. The range-determining device 330 is then rotated to aim at the center speaker and determine its range. The range is recorded in memory device 332.

The beam generator 130 and the range determining device 330 are simultaneously rotated to each new position and at each position a new speaker is placed. The range determining device 330 and memory 332 are used to insure that all the speakers are at the correct range from the reference point.

A fourth embodiment of the invention is shown somewhat diagrammatically in FIGS. 1Oa and 1Ob. The basic structure of the device is the same as the structure of the previous embodiments. The beam generators 130 and 135 comprise respective optical ranging devices 400, 402. The ranging device 400 consists of a light source 405 such as an incandescent lamp. Light from the light source 405 is transformed into collimated light by the lens 410. The collimated light impinges upon the reticule 415 and is then projected as a shadow 425 onto the respective speakers. The focusing lens 420 focuses the collimated light with the shadow of the reticule to provide a distinct shadow of the reticule 415. FIG. 1Ob illustrates an example of the reticule 415. The reticule is formed of perpendicular lines that form a “crosshair,” which provides a distinct target upon the object to be placed. Device 402 is similar to device 400.

In use the two beam generators with optical ranging devices are first oriented toward the speaker CF and the focusing lenses are then adjusted so that sharp images are obtained thereon.

To place the next speaker, the beam generators with the optical devices 400, 402 are simultaneously rotated as described above. The speaker is then that the of the two reticules 415 from each device 400, 402 fall centrally on the speaker.

FIGS. 11a and 11b show a fifth embodiment of the device. The structure of this embodiment is generally the same as described above for FIGS. 2 and 3. The device 10a includes a supporting base plate 500, which is a generally circular disk shaped and adapted to receive at its center an azimuth locating mechanism 550. Mechanism 550 includes an L-shaped bracket pivot arm 505 formed of two bars 505a and 505b, and an altitude adjustment bracket 510. The bracket pivot arm 505 is mounted at the center of the supporting base plate 500 by the azimuth locking mechanism 556. When the azimuth locking mechanism 556 is secured, the pivot bracket 505 is unable rotate about the center of the supporting base plate 500. When the azimuth locking mechanism 550 is released, the pivot bracket 505 can be rotated about a vertical axis passing through the center of the supporting base plate 500.

The altitude adjustment bracket 510 is mounted on a top end of bar 505b. A beam generator 530 is placed in an opening (not shown) within the altitude adjustment bracket 510 and secured with a set screw 545.

The beam generator 530 is shown in more detail in FIG. 11b. It comprises a light source 585 such as an incandescent lamp. Light from the light source 585 is converted into a collimated light beam by a lens 587. The collimated light impinges upon the reticule 590 to be projected as a shadow 580 on the speakers. The focusing lens 595 focuses the collimated light with the shadow 580 of the reticule to provide a distinct shadow of the reticule 590. As shown in FIG. 11a, preferably the reticule 590 is arranged and constructed so as to form a shadow 580 comprising an image formed of a circle consisting of equal angled arcs, alternate arcs having different colors. For example the arcs could be white and black. Other color combinations or images may be chosen as well to generate an optical effect generally termed a ‘pinwheel’ effect.

This embodiment of the device is operated as follows. The device 10a is placed at the reference point CC. One of the speakers, indicated in FIG. 11a as speaker 575, is placed at a predetermined distance D from device 1Oa.

The altitude-adjusting arm 510 is arranged and constructed so that the vertical axis X-X passes through the beam generator 530 and the beam generator 530 generates a beam 532 which is perpendicular both to arm 520 and axis X-X.

Once the speaker 575 is placed as described above, the beam generator 530 is rotated by the arm 510 using the height adjusting mechanism to place the shadow 580 on speaker 575. Next, the focusing lens 595 is adjusted by moving it along the longitudinal axis of beam generator 530 thereby causing the shadow 580 to appear as a clear and distinct image on the speaker 575. The azimuth angles of the speakers can be defined by pointers similar to the once in FIGS. 2 and 3 which have been omitted herein for the sake of clarity.

To place the next speaker, the azimuth locking mechanism 556 is released and the azimuth positioning arm 550 is rotated about axis X-X until the position of that object is reached, as indicated by the appropriate prompter. Once that position is reached, the azimuth locking mechanism 556 is secured. The speaker is then positioned in front of the device 10b in such a manner that the shadow 580 falls on a front face of the speaker 575. The speaker is then moved radially in and out along beam 532 until the image 580 becomes sharp and distinct.

As previously discussed, the distance D between the device 10, 1OA and the speakers can be determined by using a ruler or other conventional means. Alternatively, an electronic distance measuring apparatus may be mounted on the device 10 as discussed in association with the embodiments of FIGS. 8 and 9. Finally, in the embodiments of FIGS. 2-7 and 10 the angle between the beam generators may be used as a distance indicia, while in the embodiment of FIGS. 11a and FIGS. 11b the position of the focusing lens 595 may be used as the distance indicia.

In the embodiment of FIGS. 2-6 the pointers 155,160, 165, 170,175 are associated with the base plate 100 while the direction indicator 156 is associated with the azimuth locating mechanism. The location of these elements may be reversed as well.

While this invention has been particularly shown and described with reference to the preferred embodiments thereof, it will be understood by those skilled in the art that various changes in form, details and modifications may be made without departing from the spirit and scope of the invention.

We claim:

1. A device for positioning several objects with respect to a reference point comprising:
a base having a center;
a plurality of pointers arranged radially with respect to said center, each pointer indicating an angular position for one of said objects; and
an azimuth locating mechanism rotatably mounted on said base and including a beam generator adapted to generate a light beam, wherein said azimuth locating mechanism is adapted to position said beam generator to orient said light beam along one of said pointers thereby indicating a position for the respective object.

2. The device of claim 1 further comprising a distance calculator mounted on said azimuth locating mechanism and adapted to indicate a distance to one of said objects.

3. The device of claim 1 wherein said pointers are associated with said plate.

4. The device of claim 1 wherein said azimuth locating mechanism includes a direction indicator that indicates the orientation of said azimuth locating mechanism with respect to said pointers.

5. The device of claim 1 wherein said azimuth locating mechanism is adapted to allow said beam generator to rotate with respect to a plane parallel to the base to allow said object to be positioned in a plane offset from the base.

6. The device of claim 1 wherein said azimuth locating mechanism includes a first and a second beam generator, said beam generators being adapted to be selectively rotatable with respect to each other, said beam generators generating images on the object to be positioned.

7. The device of claim 6 wherein said beam generators are adapted to generate spots on the object to be positioned, the relative position of the spots being indicative of the position of the object.

8. The device of claim 1 wherein said azimuth locating mechanism includes a distance indicating mechanism adapted to indicate a radial distance to the object to be positioned.

9. The device of claim 8 wherein said distance indicating mechanism is an acoustic device.

10. The device of claim 8 wherein said distance indicating mechanism is a radar device.

11. The device of claim 8 wherein said distance indicating mechanism is an optical device.

12. A device for optimal positioning a plurality of speakers of a multi-speaker sound system with respect to a reference point, said device comprising:
a base;
an azimuth locating mechanism mounted on said base and rotatable about said center point, said azimuth locating mechanism including a first beam generator adapted to generate a beam of light to indicate an angular position for said speakers; and
a distance indicator adapted to indicate when a distance between said device and a respective speaker within a predetermined range.

13. The device of claim 12 further comprising a plurality of pointers arranged radially around a center point, each pointer indicating a position for one of said speakers.

14. The device of claim 13 further comprising a location indicator adapted to indicate the relative position of said azimuth locating mechanism and said pointers.

15. The device of claim 13 wherein said base is a disk shaped plate with a top surface and wherein said pointers are arranged on said top surface.

16. The device of claim 14 wherein said base is a disk shaped plate with a side surface and wherein said pointers are arranged on said side surface.

17. The device of claim 12 further comprising a second beam generator adapted to generate a second light beam, wherein when said light beams impinge on one of said speakers, they indicate the optimal position for that speaker.

18. The device of claim 17 wherein said beam generators are laser devices.

19. The device of claim 18 wherein said beam generators are optical devices adapted to generate respective images.

20. The device of claim 17 wherein said azimuth locating mechanism includes an altitude adjustment bracket, said beam generators being mounted on said altitude adjustment bracket, said altitude adjustment bracket being movable to direct beams from said beam generators at speakers disposed in a plane spaced away from a plane of said base.

21. The device of claim 17 wherein said beam generators are adapted to generate respective beams which, when impinging on one of said speakers, are offset in a predetermined direction.

22. The device of claim 12 wherein said distance indicator comprises an acoustic device.

23. The device of claim 12 wherein said distance indicator comprises a radar device.

24. The device of claim 12 further comprising a lock adapted to secure said azimuth locating mechanism in one of several predetermined positions with respect to said base.

25. A method of locating speakers of a multi-speaker system at optimal positions with respect to a reference point, said method comprising:
placing a speaker locating device at said reference point, said speaker locating device including a beam generator rotatable about an axis passing through said reference point and generating a light beam;
placing a first speaker along a first axis passing through said reference point;
directing said light beam at said first speaker to define a reference line;
rotating said beam generator by a predetermined angle with respect to said reference line to define a second axis; and
a placing a second speaker on said second axis.

26. A method of placing a plurality of speakers at predetermined angles and a common distance from a reference point, said method comprising:
placing a speaker locating device at said reference point, said speaker locating device including an azimuth locating mechanism including a first and a second beam generator, said beam generators being rotatable with respect to each other, said azimuth locating mechanism being rotatable about an axis passing through said reference point;
placing a first speaker in a first position spaced at said common distance from said reference point;
directing said beam generators at said first speaker along a reference axis and rotating them with respect to each other to obtain spots on said speaker having a predetermined spatial relationship;
fixing the relative position of wherein beam generators with respect to each other;
rotating azimuth locating mechanism to a position defined by a second axis at a predetermined angular offset from said reference axis;
placing a second speaker along said second axis with said spots impinging on said second speaker; and
adjusting the position of said second speaker until said spots are approximately in said predetermined spatial relationship.

27. The method of claim 26 wherein said spots are offset along a first line in said predetermined spatial relationship, said first line being transversal to said first and second axes.

28. The method of claim 26 wherein the distance between said first speaker and said reference point is determined using a separate distance detector.

29. The method of claim 26 wherein the distance between said first speaker and said reference point is determined using said speaker locating device.

30. The method of claim 26 wherein said first and second beam generators are locked with respect to each other while said azimuth locating mechanism is rotated.

1. An object aligning device to place a plurality of objects at a predetermined position with respect to a reference point, whereby said object aligning device comprises:
a supporting base having a center to be placed at the reference point;
a first beam generator coupled to said supporting base and generating a first beam; and
a second beam generator coupled to said supporting base and generating a second beam;
said first and second generators cooperating to define a circle around said reference point by the convergence of said beams as said generators are rotated simultaneously about said reference point so that said speakers can be positioned at a common distance from said reference point by placing along said circle.

32. The object aligning device of claim 31 further comprising a first bracket joined to and being rotatable with respect to said supporting base about said reference point, said first beam generator being mounted on said first bracket.

33. The object aligning device of claim 32 further comprising a second bracket joined to the first bracket, said second beam generator being mounted on said second bracket, said second bracket being rotatable with respect to said first bracket.

34. The object aligning device of claim 33 further comprising a first locking mechanism to selectively allow the first bracket to rotate the first beam generator about the center of the supporting base and to selectively secure the bracket from movement.

35. The object aligning device of claim 33 further comprising a second locking mechanism to selectively allow the second bracket to move said second beam generator about the center of the supporting base and to selectively secure said second beam generator from movement.

36. The object aligning device of claim 31 further comprising an elevation adjustment mechanism to adjust the position of the first and second beam generators such that the first and second reference markers selectively are moved from a plane containing said supporting base.

37. The object aligning device of claim 33 wherein the first bracket comprises an altitude adjustment mechanism to selectively adjust the first and second beam generators such that the first and second reference markers are moved from a reference plane containing the center reference point.

38. The object aligning device of claim 31 wherein the first and second beam generators are selected from a group of reference pointers consisting of laser devices, radar range detectors, ultrasonic range detectors, and optical projectors.

39. The object aligning device of claim 31 wherein the objects to be placed are speaker in a multiple speaker sound system.

40. The object aligning device of claim 31 further comprising a pedestal coupled to said supporting base to maintain the center of the supporting base at the reference point, when said reference point is at a distance from a support structure.

41. The object aligning device of claim 31 further comprising indicia placed on said supporting base indicating a primary azimuth denoting a direction to said first object and at least one secondary azimuth denoting directions corresponding to the remaining objects to be positioned.

42. A speaker aligning device to place a plurality of speakers at an equal distance from a reference point, wherein said speaker aligning device comprises:
a supporting base having a center to be placed at said reference point;
a first beam generator coupled to said supporting base;
a second beam generator coupled to said supporting base and rotatable with respect to said fist beam generator;
a first lock arranged to secure said first beam generator with respect to the second beam generator while said beam generators are moving with respect to said base.

43. The speaker aligning device of claim 42 further comprising a first bracket joined to said supporting base at the center of said supporting base.

44. The speaker aligning device of claim 43 further comprising a second bracket joined to the first bracket to support the second beam generator while allowing said second beam generator to be rotated about the center of the supporting base.

45. The speaker aligning device of claim 43 further comprising a first locking mechanism to selectively allow the first bracket to move to rotate the first beam generator about the center of the supporting base and to secure the first beam generator from movement.

46. The speaker aligning device of claim 44 further comprising a second locking mechanism to selectively allow the second bracket to move to rotate the second beam generator about the center of the supporting base and to secure the second beam generator from movement.

47. The speaker aligning device of claim 42 further comprising an elevation adjustment mechanism to adjust the first and second beam generators such that the first and second reference markers selectively are moved from a plane containing said supporting base.

48. The speaker aligning device of claim 42 wherein the first bracket comprises an altitude adjustment mechanism to selectively adjust the first and second beam generators such that the first and second reference markers are moved from a reference plane containing the reference point.

49. The speaker aligning device of claim 42 wherein the first and second beam generators are selected from a group of reference pointers consisting of laser devices, radar range detectors, ultrasonic range detectors, and optical projectors.

50. The speaker aligning device of claim 42 wherein the speakers to be placed are in a surround sound system.

51. The speaker aligning device of claim 42 further comprising a pedestal coupled to said supporting base to maintain the center of the supporting base at the reference point.

52. The speaker aligning device of claim 42 further comprising indicia placed on said supporting base indicating azimuth designations for each speaker.
